(19) United States
(12) Patent Application Publication
(10) Pub. No.: US 2009/0056478 A1
(43) Pub. Date: Mar. 5, 2009

(54) DEVICE FOR DETECTING DEFECTIVE SIEVES IN MILLING PROCESSES

(76) Inventor: Jose Luis Lopez Barreiro, Camponaraya (ES)

Correspondence Address: KNOBBE MARTENS OLSON & BEAR LLP, 2040 MAIN STREET, FOURTEENTH FLOOR, IRVINE, CA, 92614, US

(21) Appl. No.: 12/183,555

(22) Filed: Jul. 31, 2008

(30) Foreign Application Priority Data
Aug. 3, 2007 (ES) U200701682

(51) Int. Cl. G01N 15/00

(52) U.S. Cl. 73/865.5

(57) ABSTRACT

Device for detecting defective sieves in milling processes, allowing to detect and warn of the passing of particles of larger size than those selected through the pre-established sieve and which takes place in a milling, cutting or shredding process or machine of products, wherein the corresponding dragging conduit of the milled product towards the respective outlet has a sampler, which is constituted by of small window wherethrough part of the product exits, falling into a special tray with a sieve, the gauge whereof having a gauge equal to that of the sieve corresponding to the milling process, that special tray diverting the larger sized particles towards a provisional tank wherein are located two detectors at different levels, to send signals that particles of larger size than that pre-established are passing.

### OBJECT OF THE INVENTION

The present invention relates to a device for detecting defective sieves in milling processes, intended for its application in any type of machine that performs milling, cutting, shredding, etc., of any product and in any type of industry, being particularly devised for its application in the milling of grains.

The object of the invention to detect certain anomalies, such as the passing of particles that are larger than those permitted by the sieve used in the milling process, so as to achieve a homogenous product and without particles of a size larger than that pre-established.

In addition to the detection of possible defects or cracks in the sieves used in the milling processes or machine, the device of the invention also serves to detect the existence of larger than expected particles within the flow of any product, having to establish from what size particles are to be detected, and bearing in mind the percentage of existing particles in the product.

### BACKGROUND OF THE INVENTION

As is known, in milling processes sieves are used with a certain gauge according to the size of the particles that one wants to obtain, so that by virtue of that sieve gauge, only those particles of the pre-established size will pass through, the particles of larger size remaining in the upper part of the sieve to be evacuated to the exterior, all with the object of achieving a product with uniform particles, as is the case of the milling of grains, the obtainment of flour, etc.

In the event that a sieve has a defect, such as a small crack that allows the passage therethrough of particles of larger size than that pre-established, the detection thereof is not made automatically; in the best of cases, it is detected visually by the operators, although in most cases, that detection is made very late and the product obtained includes particles of larger size than that desired, so that sometimes it is necessary to start to mill the entire product all over again, when a noticeable precision or fineness is desired.

In short, no milling process or machine is known that performs a measurement, either continuously or at time intervals, of the passage of particles of larger size than that pre-established and corresponding to the gauge of the sieve, nor, of course, is there any system which permits the separation of those particles of larger size with respect to the appropriately sized particles.

### DESCRIPTION OF THE INVENTION

The device proposed has been designed to resolve the aforementioned problem, by using a simple but effective solution.

More specifically, the device of the invention is characterised in that it includes a tray at the outlet of a sample of the product established in the dragging thereof from the place where the milling process occurs to the collecting place, so that through that sampler, the product falls into the aforementioned special tray which is gauged in the same manner as the sieve used in the milling process, so that if the fallen product has its particles of normal gauge in that sampler, then they fall through the special tray and rejoin the flow of the rest of the product, whilst if there are larger particles than that pre-established, they are moved to a secondary compartment determining a provisional tank of the product detected; i.e. of the larger sized particles, the compartment or tank wherein having two level detectors, one close to the bottom and another in a higher position, which detect the existence of product, or in other words particles larger than that expected, giving the corresponding signal and notifying the control panel of the existence of an anomaly in the normal sieve used in the milling, whilst if those particles reach the upper level of said provisional compartment or tank, then a new warning of the detected anomaly is given.

The provisional compartment or tank includes a sash-gate below the outlet of those undesired particles or product, which opens into the product reincorporation channel to the corresponding flow.

Clearly, once the signals on the control panel are seen by the person in charge, they will act accordingly, either stopping the milling process, changing the sieve, etc.

Optionally, the device could also be installed under an auger conveyor or discharge pipes wherethrough the milled product would pass, all of this without affecting the essence of the invention.

In this way, it is impossible that in a milling of any type, any particles larger than those allowed by the sieve could pass, since those possible particles of larger size are detected and then collected in a secondary compartment or tank which sends them back to the flow of the product to again pass through the milling process.

### DESCRIPTION OF THE DRAWINGS

In order to complement the description which will be made below and with the aim of helping towards a better understanding of the characteristics of the invention, in accordance with a preferred practical embodiment thereof, a set of drawings have been included as an integral part of said description wherein the following, in an illustrative and non-limitative character, has been represented:

FIG. 1.—Shows a schematic representation according to a side elevational view of the device of the invention applied to a milling process of products, such as grains.

FIG. 2.—Shows a view such as that of the previous figure, with the device detecting particles of larger size than that pre-established.

FIG. 3.—Shows, finally, a view such as that of the previous figure discharging the particles of larger size detected by the device of the invention towards a channel which reincorporates the product back into the flow intended to be milled again.

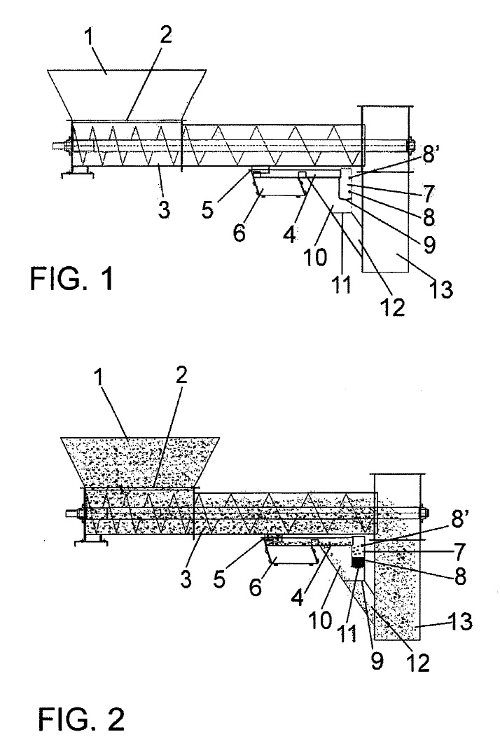

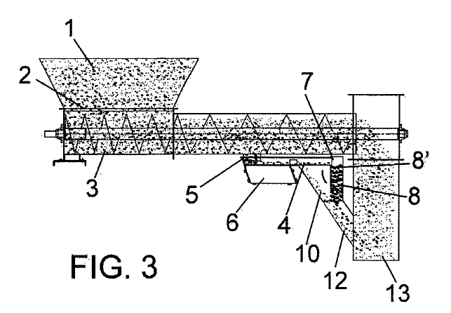

### PREFERRED EMBODIMENT OF THE INVENTION

As can be observed in the referred to figures, the device of the invention, applicable to a milling machine or process, with a hopper chute (1), a sieve (2) for the passage of particles, and a transport conduit (3), such as an auger conveyor or suchlike; starting with these characteristics, the device of the invention is constituted from a special tray (4) situated at the outlet of a sampler (5) disposed in the flow conduit (3) of the milled product, a sampler (5) materialized in a small window in that conduit (3) so that through 61, samples are taken that will go directly to the tray (4), to the passage of the flow of the milled product along the conduit (3) towards its outlet, said tray (4) having the complement of a vibrating element (6) and at the outlet thereof a provisional tank or compartment (7) for particles of larger size than that pre-established, the provisional tank or compartment whereof having two set levels, one lower (8) and another higher (8′), all so that the special tray (4) situated at the outlet of the sampler (5) has a gauge equal to that of the sieve (2) provided in the machine of the milling process.

The provisional compartment or tank (7) has a lower sash-gate (9) which opens into an area (10) whereinto the special tray (4) discharges and the discharging area (10) whereof includes a sash-gate (11) which opens into a conduit (12) which transports the product towards the tank (11) wherein the recirculation of the product that comes out of both the provisional tank (7) and the tray (4) takes place.

In this way, the product dragged along the conduit (3) towards the outlet, an already milled product, goes to the same part thereof through the sampler (5) towards the tray (4), so that this being of the same gauge as the sieve (2) of the milling, it will let the product pass towards the area (10), opening the sash-gate (11) and going from the conduit (12) towards the recirculation area (13), integrating that product that falls onto the tray (4) back into the flow of the product to be milled.

However, when the product that goes through the sampler (5) to the tray (4) has larger sized particles, then they do not pass through the aforementioned special sieve and go to the provisional tank or compartment (7), which upon reaching a certain level, highlighted by the detector (8), as is represented in FIG. 2, the corresponding signal is sent indicating the anomaly that larger sized particles are passing.

That tank (7) can be filled with those larger sized particles coming from the special tray (4), until reaching the second level (8′), in which case a second warning of the anomaly or detection of a defect or crack of the sieve (2) will be sent, discharging those larger sized particles through the sash-gate (9) so that they fall to the area (10) and therefrom through the trap door (11), to the conduit (12) for its recirculation back into the flow (13) of the product to be milled.

Therefore, through the sampler (5), part of the flow which circulates through the conduit (13) towards the outlet enters towards the special tray (4), normally exiting through the sieve thereof, and in the event that there is no particle larger than that established, that product goes to the area (10), which falls due to gravity through the special tray (4), exiting through the conduit (12) towards the part (13) wherein it rejoins the flow of the product, continuing the milling process, so that in this case, as there are no larger sized particles, no warning is given whatsoever.

Nevertheless, when larger sized particles go into the tray (4), they pass to the provisional compartment or tank (7) and they will be deposited therein until reaching the detector (8), which sends a signal of the corresponding anomaly, and in the event that the process continues operating, those larger sized particles will be stored in that provisional tank (7) until reaching the second detector (8′), sending another warning, and then moving on to the opening of the sash-gate (11) of said provisional tank (7) and the larger sized particles falling towards the conduit (12) for their reincorporation into the area (13) corresponding to the flow of the product to be milled.

In this way, the device of the invention fulfils its task of warning that there are particles of larger size than that pre-established passing, so that it acts accordingly, although in no case do those larger sized particles pass through with the product whose particles are of the pre-established size.

1. A device for detecting defective sieves in milling processes, which is intended to detect and warn of the passing of particles of larger size than those selected through the pre-established sieve and which takes place in a milling, cutting or shredding process or machine, of products such as grains or others, characterised in that in the corresponding dragging conduit of the milled product towards the respective outlet, a sampler has been provided, comprising a small window wherethrough part of the product exits, falling into a special tray with a sieve, the gauge whereof having a gauge equal to that of the sieve corresponding to the milling process, said special tray or sieve permitting the passage of the normal particles, and diverting the larger sized particles, in the event that there are any, towards a provisional tank or compartment comprising two detectors at different levels, to send signals that particles of larger size than that pre-established are passing.

2. The device according to claim 1, characterised in that the provisional compartment or tank wherein the detectors are located stores those larger sized particles coming from the tray or special sieve, having a lower sash-gate which discharges those larger sized particles towards a common area at the outlet of the special tray or sieve, both one and the other product going towards a conduit which opens into the corresponding flow recirculation area of the product for its reincorporation to the flow of the milling process.

3. A device for detecting defective sieves in milling processes, comprising:
a sampler window;
a tray comprising a sieve; and
a provisional compartment or tank.

4. The device of claim 3, wherein the guage of said sieve is of the same guage as the milling sieve being detected.

5. The device of claim 3, wherein said provisional compartment or tank comprises at least one detector, capable of sending a signal that particles of larger size than pre-established are passing through a defective sieve.

6. The device of claim 5, wherein said provisional compartment or tank comprises a lower sash-gate.
